(19) United States
(12) Patent Application Publication
(10) Pub. No.: US 2006/0219232 A1
(43) Pub. Date: Oct. 5, 2006

(54) FLOATING BLADE APPARATUS FOR CUTTING CONCRETE

(76) Inventor: Charlie Zhang, Oak Brook, IL (US)

Correspondence Address: Kevin D. Erickson;Pauley Petersen & Erickson, Suite 365, 2800 West Higgins Road, Hoffman Estates, IL, 60195, US

(21) Appl. No.: 11/098,630

(22) Filed: Apr. 4, 2005

(51) Int. Cl. B28D 1/04

(52) U.S. Cl. 125/13.01

(57) ABSTRACT

A floating blade apparatus for cutting a surface of concrete, particularly, green concrete. The apparatus includes a body frame and a cutting blade support frame operationally connected with the body frame. The cutting blade support frame relatively freely permitting a range of movement of a rotatable cutting blade relative to the surface of concrete over which the apparatus is conveyed. The apparatus may also include conventional features such as a conveyance system, a motor and a handle.

### BACKGROUND OF THE INVENTION

This invention relates generally to concrete and, more particularly, to an apparatus for cutting concrete. More specifically, the invention relates to a concrete cutting apparatus particularly suited for cutting “green” or not fully cured concrete and which apparatus, as more fully described below, incorporates or utilizes a floating blade.

The surfaces of large slabs of concrete are known to be prone to cracking such as may occur as a result of expansion and contraction as the slab of concrete cures. Such expansion and contraction of a concrete slab are typically dependent on numerous factors. In view thereof, various techniques or approaches for avoiding, reducing or otherwise effectively controlling such cracking have been proposed or developed. One commonly employed approach for avoiding, reducing or otherwise effectively controlling such cracking is through the introduction of control joints or seams in the surface of the concrete as the concrete is curing.

While such control joints or seams can be created or established by various techniques, the cutting of a concrete surface by means of a saw or blade is an established technique for forming or introducing such control joints or seams into a concrete surface. In particular, the formation of cuts or grooves in relatively fresh, e.g., green, concrete slabs is a common technique that has been employed to avoid, reduce or otherwise effectively control such cracking. As used herein, “green concrete” generally refers to not yet fully cured concrete and, more specifically, to concrete within one to several hours after pouring such as dependent, at least in part, on the concrete mixture that is being employed.

When cutting or forming such control joints or seams in a concrete surface, it is generally desirable to avoid or minimize otherwise marking or marring the surface of the concrete in the vicinity of the joint or seam. That is, it is generally desirable that the joint or seam be cleanly cut or otherwise formed in the concrete surface such that surface chipping, spalling or ravelling is minimized or avoided. Moreover, at least for appearance sake, it is generally desired that such cut control joints or seams be formed in relatively straight line fashion.

Those skilled in the art will appreciate that newly laid concrete, in particular green concrete such that has just begun to cure cannot readily support heavy machinery or equipment, such as may otherwise be desirably employed to effect the cutting of the surface of the concrete. In particular, the weight of such heavy machinery or equipment bearing on the not yet cured concrete surface may result in undesirable surface marking or degradation.

Consequently, various hand-operated concrete cutting assemblies, including various manually-operated, walk-behind concrete cutting assemblies, have been developed. While such manually-operated, walk-behind concrete cutting assemblies are generally effective in the control joint or seam cutting of concrete surfaces, further improvements with regard to efficiency and ease of operation have been continually sought.

Thus, there is an ongoing need and demand for improvements in such assemblies such as improvements directed to facilitate or better ensure that the resulting cut control joints or seams are desirably formed in a relatively straight line fashion and further to facilitate manual, e.g., walk-behind, operation of the cutting apparatus.

### SUMMARY OF THE INVENTION

A general object of the invention is to provide an improved apparatus for cutting concrete.

A more specific objective of the invention is to overcome one or more of the problems described above.

The general object of the invention can be attained, at least in part, through a floating blade apparatus for cutting a surface of concrete over which the apparatus is conveyed. The apparatus includes a body frame having opposed and spaced apart lead and trail ends. The body frame also has opposed and spaced apart first and second lateral sides. The apparatus further includes a conveyance system that includes at least one wheel connected to the body frame. The conveyance system permits the apparatus to be conveyed over the surface of concrete. A cutting blade support frame is operationally connected with the body frame. The cutting blade support frame includes a blade mount for a rotatable cutting blade. The cutting blade support frame permits vertical movement of the rotatable cutting blade relative to the surface of concrete over which the apparatus is conveyed. A motor is fixedly connected with the body frame. The motor is in operational communication with the rotatable cutting blade effective to rotate the cutting blade to cut into the surface of concrete over which the apparatus is conveyed. The motor is also in operational communication with the conveyance system whereby the apparatus is conveyable over the surface of concrete. A handle is fixedly connected to the body frame and is effective for guiding the apparatus across a surface of concrete to be cut.

The prior art generally fails to provide an apparatus for cutting concrete, particularly green concrete, and which apparatus desirably facilitates or better ensures that the resulting cut control joints or seams are desirably formed in a relatively straight line fashion and further facilitates manual, e.g., walk-behind, operation of the cutting apparatus. In addition, a floating blade apparatus in accordance with the invention self-regulates proper cutting of concrete, that is, if the apparatus is moved too quickly, the blade desirably raises out of the concrete to visually and audibly indicate that a complete cut has not been effected.

A floating blade apparatus for cutting a surface of concrete over which the apparatus is conveyed, in accordance with another embodiment of the invention includes a body frame and a cutting blade support frame operationally connected with the body frame. The body frame has opposed and spaced apart lead and trail ends and also has opposed and spaced apart first and second lateral sides. The cutting blade support frame includes a first arm generally disposed along the first lateral side of the body frame and a second arm generally disposed along the second lateral side of the body frame. The first arm has a first arm attachment point with the body frame. The second has a second arm attachment point with the body frame. The cutting blade support frame also includes a cross bar joining the first and the second arms and includes a blade mount for a rotatable cutting blade. The cutting blade support frame simultaneously permits vertical movement of the rotatable cutting blade relative to the surface of concrete over which the apparatus is conveyed and arcuate movement of the rotatable cutting blade relative to at least one of the first arm and second arm attachment points.

The apparatus further includes a conveyance system including at least a pair of trail end wheels connected to the body frame. The conveyance system permits the apparatus to be conveyed over the surface of concrete. A motor is fixedly connected with the body frame. The motor is in operational communication with the rotatable cutting blade effective to rotate the cutting blade to cut into the surface of concrete over which the apparatus is conveyed. The motor is also in operational communication with the conveyance system whereby the apparatus is conveyable over the surface of concrete. A handle is fixedly connected to the body frame and is effective for guiding the apparatus across a surface of concrete to be cut.

In accordance with another embodiment, the invention comprehends a floating blade apparatus for cutting a surface of concrete over which the apparatus is conveyed and which apparatus additionally includes a biasing device effective to maintain a rotatable cutting blade in cutting contact with the surface of concrete over which the apparatus is conveyed. The apparatus includes a body frame and a cutting blade support frame operationally connected with the body frame. The body frame has opposed and spaced apart lead and trail ends and also opposed and spaced apart first and second lateral sides. The cutting blade support frame includes a first arm generally disposed along the first lateral side of the body frame and a second arm generally disposed along the second lateral side of the body frame. The first arm has a first arm attachment point with the body frame. The second has a second arm attachment point with the body frame. The cutting blade support frame also includes a cross bar joining the first and the second arms and includes a blade mount for a rotatable cutting blade. The cutting blade support frame simultaneously permits vertical movement of the rotatable cutting blade relative to the surface of concrete over which the apparatus is conveyed and arcuate movement of the rotatable cutting blade relative to the first arm and second arm attachment points. In addition, the cutting blade may be locked into a fixed position using a locking mechanism.

The apparatus includes a conveyance system to permit the apparatus to be conveyed over the surface of concrete. The conveyance system includes at least first and second trail end wheels and a lead end roller each connected to the body frame. The first trail end wheel is connected to the body frame at the first lateral side. The second trail end wheel is connected to the body frame at the second lateral side.

A motor is fixedly connected with the body frame. The motor is in operational communication with the rotatable cutting blade and is effective to rotate the cutting blade to cut into the surface of concrete over which the apparatus is conveyed. The motor is also in operational communication with the conveyance system whereby the apparatus is conveyable over the surface of concrete. As described, the apparatus preferably reduces or dampens vibration between the motor and the operator and between the motor and the cutting blade.

A handle is fixedly connected to the body frame and is effective for guiding the apparatus across a surface of concrete to be cut.

Other objects and advantages will be apparent to those skilled in the art from the following detailed description taken in conjunction with the appended claims and drawings.

### BRIEF DESCRIPTION OF THE DRAWINGS

FIG. 1 is a fragmentary perspective view of a floating blade apparatus for cutting concrete in accordance with one preferred embodiment of the invention.

FIG. 2 is a simplified perspective view showing portions, including at least portions of the body frame, conveyance system, cutting blade support frame, biasing device and handle of the floating blade apparatus for cutting concrete in isolation, e.g., without the covering body elements or motor, such as shown in FIG. 1.

FIG. 3 is a simplified perspective view showing portions, including at least portions of the body frame, conveyance system, cutting blade support frame and handle of a floating blade apparatus for cutting concrete in accordance with another preferred embodiment of the invention and, as in FIG., in isolation, e.g., without the covering body elements or motor.

FIG. 4 is a top plan view of the isolated portions of the floating blade apparatus for cutting concrete shown in FIG. 3.

FIG. 5 is a simplified cross sectional side view of the isolated portions of the floating blade apparatus for cutting concrete shown in FIGS. 3 and 4 and taken along the line 5-5 in FIG. 4.

### DETAILED DESCRIPTION OF THE INVENTION

The present invention provides a floating blade apparatus particularly suited for cutting “green” or not fully cured concrete.

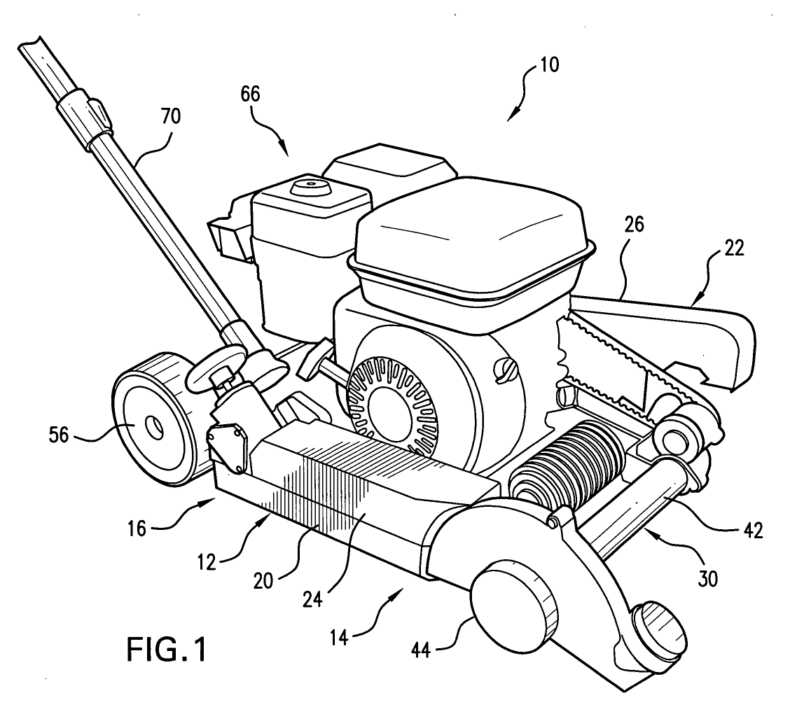

Turning to FIG. 1, there is illustrated a floating blade, concrete cutting apparatus, generally designated by the reference numeral 10, in accordance with one preferred embodiment of the invention. The floating blade, concrete cutting apparatus 10 generally includes a body frame 12. The body frame 12 has a lead or forward end 14 and a trail or rear end 16 that are generally opposed and spaced apart from each other. The body frame 12 also has opposed and spaced apart first and second lateral sides, 20 and 22, respectively. As shown, the apparatus 10 may desirably include side coverings, individually designated 24 and 26, generally disposed at or along the first and second lateral sides 20 and 22, respectively.

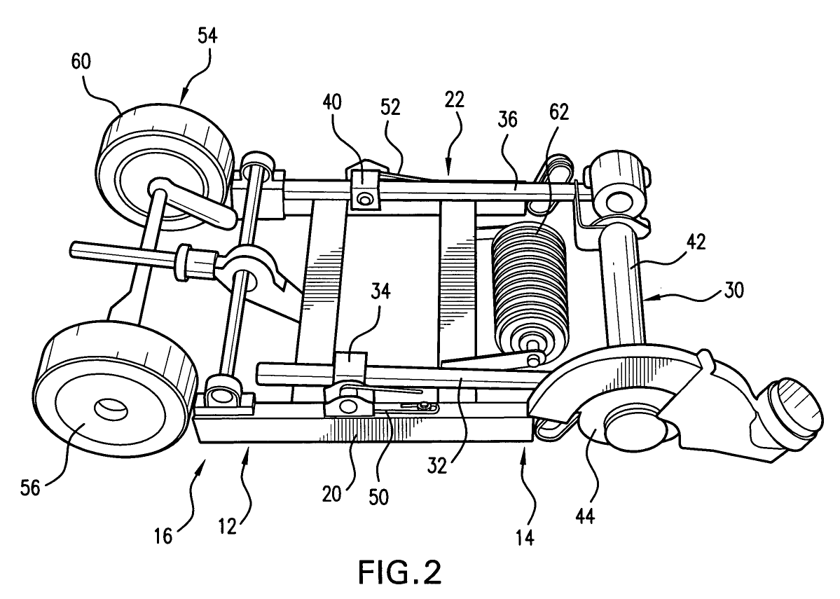

As perhaps best viewed by reference to FIG. 2, wherein covering components such as the side coverings 24 and 26 have been removed, the apparatus 10 includes a cutting blade support frame 30 operationally connected with the body frame 12. In accordance with one preferred embodiment and as illustrated, the cutting blade support frame 30 includes a first arm 32 generally disposed along the first lateral side 20 of the body frame 12 and having a first arm attachment point 34 with the body frame 12. The cutting blade support frame 30 also includes a second arm 36 generally disposed along the second lateral side 22 of the body frame 12 and having a second arm attachment point 40 with the body frame 12. The cutting blade support frame 30 further includes a cross bar 42 joining the first arm 32 and the second arm 36. The cross bar 42 includes, either as a part of the cross bar or as an extension therefrom, a blade mount 44 whereat a rotatable cutting blade (not shown) is disposed or otherwise appropriately mounted.

As will be appreciated by those skilled in the art and guided by the teachings herein provided, such a cutting blade support frame 30 desirably simultaneously permits vertical movement of the rotatable cutting blade relative to the surface of concrete over which the apparatus 10 is conveyed and also arcuate movement of the rotatable cutting blade relative to the first arm and second arm attachment points (such as movement in the direction of the arrow A, shown in FIG. 2).

The apparatus of the invention provides or results in a construction sometimes referred to herein as a “floating blade” arrangement wherein the associated cutting blade is relatively freely able to adjustably move within a range of motion in response to factors such as minor surface irregularities and the like. Thus, the apparatus of the invention can desirably facilitate or better ensure that the resulting cut control joints or seams, such as formed in green concrete, are desirably formed in a relatively straight line fashion and further the cutting apparatus facilitates manual, e.g., walk-behind, operation thereof. In addition, the floating blade in accordance with the invention preferably self-regulates proper cutting of concrete, that is, if the apparatus is moved too quickly, the floating blade desirably raises out of the concrete to visually and audibly indicate that a complete cut has not been effected.

While the invention has been described above relative to an embodiment wherein the cutting blade support frame desirably simultaneously permits adjustable vertical movement of the rotatable cutting blade relative to the surface of concrete over which the apparatus is conveyed and also adjustable arcuate movement of the rotatable cutting blade relative to the first arm and second arm attachment points, it is to be understood that the broader practice of the invention is not necessarily so limited. For example, at least some of the advantages and benefits resulting from the practice of the invention may be realized through embodiments wherein the adjustable movement of the rotatable cutting blade is appropriately principally, primarily or essentially solely in the vertical direction.

Those skilled in the art and guided by the teachings herein provided will understand and appreciate that rotatable cutting blades of various design and construction, such as generally suitable for the cutting of concrete, particularly, green concrete, are available and are useable in the practice of the invention. Thus, it is to be understood that the broader practice of the invention is not necessarily limited to or by the cutting blade design or construction used in the practice thereof.

The apparatus 10 may also desirably include or contain an appropriate biasing device effective to maintain the rotatable cutting blade in cutting contact with the surface of concrete over which the apparatus is conveyed. Those skilled in the art and guided by the teachings herein provided will appreciate that various forms of biasing devices, such as known in the art, can desirably be employed in the practice of the invention. For example, in the illustrated apparatus 10, the biasing device is in the form of spring loaded arms 50 and 52 positioned in conjunction with the first and second arms 32 and 36, respectively. In addition, a locking mechanism may be used to lock the biasing device and/or the cutting blade into a fixed position relative to the apparatus 10.

The apparatus 10 further includes a conveyance system, generally designated by the reference numeral 54. Those skilled in the art and guided by the teachings herein provided will appreciate that conveyance systems of various form and structure, such as known in the art, can desirably be employed in the practice of the invention. In accordance with one preferred embodiment, the invention is desirably practiced employing a conveyance system 54 composed of a first trail end wheel 56 connected to the body frame 12 at the first lateral side 20, a second trail end wheel 60 connected to the body frame 12 at the second lateral side 22 and a roller 62, such as also appropriately connected to the body frame 12 and such as centrally disposed at or toward the frame lead end 14.

The apparatus 10 also includes a motor 66 fixedly connected with the body frame 12. The motor 66 is in operational communication with the rotatable cutting blade effective to rotate the cutting blade to cut into the surface of concrete over which the apparatus is conveyed. The motor 66 is also in operational communication with the conveyance system 54 whereby the apparatus 10 is conveyable over the surface of concrete. As a result of the relationship between the motor 66 and the cutting blade as described, the cutting blade is preferably isolated and dampened from vibrations caused by the motor 66.

In a preferred embodiment of this invention, the conveyance system 54 operates at a desirable speed so as to maintain a preferred cutting contact between the cutting blade and the green concrete. This is particularly desirable because, if the conveyance system 54 operates at an excessive speed, the cutting blade preferably rises out of the concrete to indicate, both visually and audibly, that a proper cut is not effected.

As will be understood, in conjunction with the motor 66, the apparatus 10 will typically also include ancillary components such as a fuel tank, transmission, air filter, etc. and which ancillary components do not generally form limitations on the broader practice of the invention.

The apparatus 10 also includes a handle 70 fixedly connected to the body frame 12 and effective for the guiding the apparatus 10, such as by an individual walking therebehind, as the apparatus 10 is moved across a surface of concrete to be cut. As will be appreciated, the handle 70 may have appropriate switches and/or controls (not shown), such as known in the art, mounted or connected thereto such as to facilitate walk-behind operation of the apparatus 10.

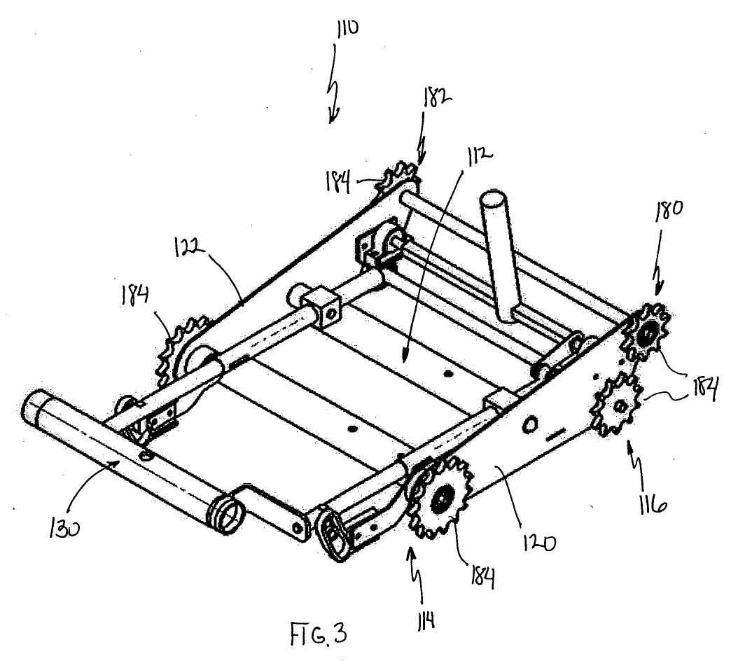

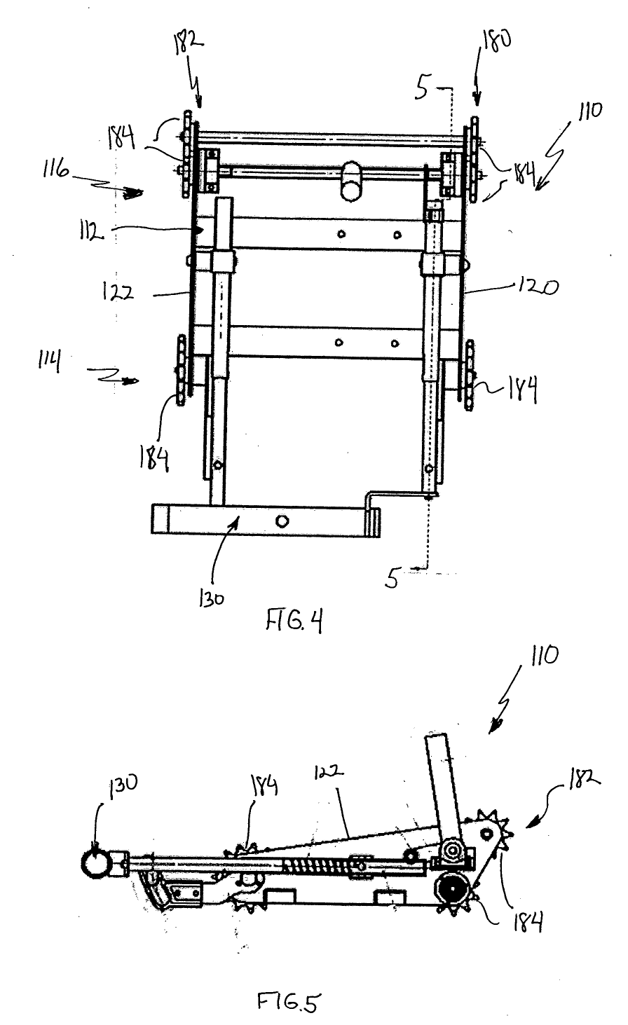

While the invention has been described above making specific reference to an embodiment having a conveyance system such as including first and second trail end wheels and a centrally positioned roller, those skilled in the art and guided by the teachings herein provided will understand and appreciate that the broader practice of the invention is not necessarily so limited. For example, referring to FIGS. 3-5, there is illustrated isolated portions of a floating blade apparatus for cutting concrete in accordance with another embodiment of the invention and generally designated by the reference numeral 110.

The apparatus 110, similar to the apparatus 10 described above, includes a body frame 112 having a lead or forward end 114 and a trail or rear end 116 that are generally opposed and spaced apart from each other. The body frame 112 also has opposed and spaced apart first and second lateral sides, 120 and 122, respectively. The apparatus 110, also similar to the apparatus 10 described above, includes a cutting blade support frame 130 operationally connected with the body frame 112.

The apparatus 110, however, primarily differs from the apparatus 10 described above by the incorporation of a conveyor belt or loop form of conveyance system. To that end, FIGS. 3-5 illustrate the inclusion of first and second side drive assemblies, individually designated by the reference numerals 180 and 182, respectively, and each generally including a plurality of sprocket wheels 184 disposed on or at the first and second body frame lateral sides, 120 and 122, respectively. As will be appreciated, an appropriate track conveyor (not shown), such as in the form of an endless flexible track such as generally composed of a plurality of aligned individual conveyor plates, can desirably be disposed about or in communication with the sprocket wheels 184. Moreover, one or both of the drive assemblies 180 and 182 can be in operational communication with an apparatus motor (not shown) so as to be effective to rotate the track conveyors, whereby the apparatus 110 is conveyable over an adjacent surface.

Thus, the invention provides an apparatus for cutting concrete, particularly green concrete, and which apparatus desirably facilitates or better ensures that the resulting cut control joints or seams are desirably formed in a relatively straight line fashion and further facilitates manual, e.g., walk-behind, operation of the cutting apparatus.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

1. A floating blade apparatus for cutting a surface of concrete over which the apparatus is conveyed, the apparatus comprising:
a body frame having opposed and spaced apart lead and trail ends, the body frame also having opposed and spaced apart first and second lateral sides;
a conveyance system comprising at least one wheel connected to the body frame, the conveyance system permitting the apparatus to be conveyed over the surface of concrete;
a cutting blade support frame operationally connected with the body frame, the cutting blade support frame including a blade mount for a rotatable cutting blade, the cutting blade support frame permitting vertical movement of the rotatable cutting blade relative to the surface of concrete over which the apparatus is conveyed, wherein the cutting blade support frame comprises:
a first arm generally disposed along the first lateral side of the body frame and having a first arm attachment point with the body frame;
a second arm generally disposed along the second lateral side of the body frame and having a second arm attachment point with the body frame; and
a cross bar joining the first and the second arms and including a blade mount for a rotatable cutting blade, the cutting blade support frame simultaneously permitting vertical movement of the rotatable cutting blade relative to the surface of concrete over which the apparatus is conveyed and arcuate movement of the rotatable cutting blade relative to at least one of the first arm and second arm attachment points;
a motor fixedly connected with the body frame, the motor in operational communication with the rotatable cutting blade effective to rotate the cutting blade to cut into the surface of concrete over which the apparatus is conveyed, the motor also in operational communication with the conveyance system whereby the apparatus is conveyable over the surface of concrete; and
a handle fixedly connected to the body frame and effective for guiding the apparatus across a surface of concrete to be cut.

2. The apparatus of claim 1 wherein the conveyance system comprises at least a pair of trail end wheels connected to the body frame.

3. The apparatus of claim 3 wherein the conveyance system additionally comprises a lead end roller connected to the body frame.

4. The apparatus of claim 1 additionally comprising a biasing device effective to maintain the rotatable cutting blade in cutting contact with the surface of concrete over which the apparatus is conveyed.

5. The apparatus of claim 4 wherein the conveyance system comprises at least a pair of trail end wheels connected to the body frame.

6. The apparatus of claim 5 wherein the conveyance system additionally comprises a lead end roller connected to the body frame.

7. (canceled)

8. The apparatus of claim 1 wherein the cutting blade support frame simultaneously permits vertical movement of the rotatable cutting blade relative to the surface of concrete over which the apparatus is conveyed and arcuate movement of the rotatable cutting blade relative to both the first arm and second arm attachment points.

9-11. (canceled)

13. A floating blade apparatus for cutting a surface of concrete over which the apparatus is conveyed, the apparatus comprising;
a body frame having opposed and spaced apart lead and trail ends, the body frame also having opposed and spaced apart first and second lateral sides;
a conveyance system comprising at least a pair of trail end wheels connected to the body frame, the conveyance system permitting the apparatus to be conveyed over the surface of concrete;
a cutting blade support frame operationally connected with the body frame, the cutting blade support frame comprising a first arm generally disposed along the first lateral side of the body frame and having a first arm attachment point with the body frame, a second arm generally disposed along the second lateral side of the body frame and having a second arm attachment point with the body frame and a cross bar joining the first and the second arms and including a blade mount for a rotatable cutting blade, the cutting blade support frame simultaneously permitting vertical movement of the rotatable cutting blade relative to the surface of concrete over which the apparatus is conveyed and arcuate movement of the rotatable cutting blade relative to at least one of the first arm and second arm attachment points;
a motor fixedly connected with the body frame, the motor in operational communication with the rotatable cutting blade effective to rotate the cutting blade to cut into the surface of concrete over which the apparatus is conveyed, the motor also in operational communication with the conveyance system whereby the apparatus is conveyable over the surface of concrete; and
a handle fixedly connected to the body frame and effective for guiding the apparatus across a surface of concrete to be cut.

14. The apparatus of claim 13 wherein the conveyance system additionally comprises a lead end roller connected to the body frame.

15. The apparatus of claim 14 additionally comprising a biasing device effective to maintain the rotatable cutting blade in cutting contact with the surface of concrete over which the apparatus is conveyed.

16. The apparatus of claim 13 additionally comprising a biasing device effective to maintain the rotatable cutting blade in cutting contact with the surface of concrete over which the apparatus is conveyed.

17. A floating blade apparatus for cutting a surface of concrete over which the apparatus is conveyed, the apparatus comprising:
a body frame having opposed and spaced apart lead and trail ends, the body frame also having opposed and spaced apart first and second lateral sides;
a conveyance system comprising at least first and second trail end wheels and a lead end roller each connected to the body frame and permitting the apparatus to be conveyed over the surface of concrete, the first trail end wheel connected to the body frame at the first lateral side and the second trail end wheel connected to the body frame at the second lateral side, the conveyance system permitting the apparatus to be conveyed over the surface of concrete;
a cutting blade support frame operationally connected with the body frame, the cutting blade support frame including a first arm generally disposed along the first lateral side of the body frame and having a first arm attachment point with the body frame, a second arm generally disposed along the second lateral side of the body frame and having a second arm attachment point with the body frame and a cross bar joining the first and the second arms and including a blade mount for a rotatable cutting blade, the cutting blade support frame simultaneously permitting vertical movement of the rotatable cutting blade relative to the surface of concrete over which the apparatus is conveyed and arcuate movement of the rotatable cutting blade relative to the first arm and second arm attachment points;
a biasing device effective to maintain the rotatable cutting blade in cutting contact with the surface of concrete over which the apparatus is conveyed;
a motor fixedly connected with the body frame, the motor in operational communication with the rotatable cutting blade effective to rotate the cutting blade to cut into the surface of concrete over which the apparatus is conveyed, the motor also in operational communication with the conveyance system whereby the apparatus is conveyable over the surface of concrete; and
a handle fixedly connected to the body frame and effective for guiding the apparatus across a surface of concrete to be cut.
